(19) United States
(12) Patent Application Publication
(10) Pub. No.: US 2011/0006721 A1
(43) Pub. Date: Jan. 13, 2011

(54) CONTROL OF AN ASYNCHRONOUS MOTOR

(75) Inventors: Laurent Gonthier, Tours (FR); Raynald Achart, Pernay (FR)

Correspondence Address: STMicroelectronics Inc.;c/o WOLF, GREENFIELD & SACKS, P.C., 600 Atlantic Avenue, BOSTON, MA, 02210-2206, US

(73) Assignee: STMicroelectronics S.A., Montrouge (FR)

(21) Appl. No.: 12/521,808

(22) PCT Filed: Jan. 4, 2008
(86) PCT No.: PCT/FR08/50010

§ 371 Date: Sep. 28, 2010

(30) Foreign Application Priority Data
Jan. 5, 2007 (FR) 0752532

(51) Int. Cl. H02P 1/40

(52) U.S. Cl. 318/772

(57) ABSTRACT

The invention relates to a device for controlling the speed and the rotation direction of an asynchronous motor (1), comprising a first circuit (7) with two bi-directional switches (T′4, T′5) individually controlled and having first conducting terminals connected to a common terminal (6) for applying a direct potential (Vcc) and having second conducting terminals that can be respectively connected to the first ends (12, 14) of windings (15, 16) of the motor stator, and a second circuit (3′) with at least two parallel bi-directional switches (T1, T2, T3) individually controlled and having first respective conducting terminals (Kᵢ) connected to the common terminal.

### CROSS REFERENCE TO RELATED APPLICATIONS

This application claims the priority benefit of French patent application Ser. No. 07/52553, filed on Jan. 5, 2007, entitled “Control of an Asynchronous Motor,” which is hereby incorporated by reference to the maximum extent allowable by law.

### BACKGROUND OF THE INVENTION

1. Field of the Invention

The present invention generally relates to asynchronous motors and, more specifically, to the control of the speed and the direction of rotation of a motor powered by an A.C. voltage.

2. Discussion of the Related Art

Generally, asynchronous motor devices require a relay-type bipolar switch to reverse the motor rotation direction. This increases the system power consumption since, for one of the two rotation directions, a current must permanently supply the relay coil.

Further, electromagnetic relays generate noise and electromagnetic disturbances, are often expensive and adversely affect the integration of the control devices.

### SUMMARY OF THE INVENTION

At least one embodiment of the present invention aims at overcoming all or part of the disadvantages of multispeed control systems reversing the direction of an asynchronous motor.

At least one embodiment of the present invention more specifically aims at avoiding the use of a relay control to reverse the rotation direction of the motor.

To achieve all or part of these and other objects, as well as others, the present invention provides a device for controlling the speed and the direction of rotation of an asynchronous motor, having:

a first circuit of two individually-controllable bidirectional switches having first conduction terminals connected to a common terminal of application of a D.C. voltage and having second conduction terminals capable of being respectively connected to first ends of windings of the motor stator;

a second circuit of at least two individually-controllable bidirectional switches in parallel, having first respective conduction terminals connected to the common terminal.

According to an embodiment of the present invention, one of the bidirectional switches of the second circuit has its second conduction terminal directly connected to a terminal of application of an A.C. voltage, the other bidirectional switches of the second circuit having their second respective conduction terminals connected, by an impedance, to this terminal of application of the A.C. voltage.

According to an embodiment of the present invention, the bidirectional switches of the second circuit have their second respective conduction terminals connected, by an impedance, to a second terminal of application of the A.C. voltage.

According to an embodiment of the present invention, the number of bidirectional switches of the second circuit is equal to the number of rotation speeds desired for the motor minus one, an impedance directly connecting the common terminal to the terminal of application of the A.C. voltage.

According to an embodiment of the present invention, the number of bidirectional switches of the second circuit is equal to the number of rotation speeds desired for the motor.

According to an embodiment of the present invention, second respective ends of the windings of the motor are capable of being connected together to another terminal of application of the A.C. voltage, a capacitive element connecting their first respective ends.

According to an embodiment of the present invention, each impedance comprises at least one capacitive element in parallel with a resistive element.

According to an embodiment of the present invention, said bidirectional switches are triacs having their cathodes directly connected to the common terminal.

According to an embodiment of the present invention, respective control terminals of the bidirectional switches are capable of being connected to output terminals of a control circuit providing two-state signals.

The present invention also provides a device having an asynchronous motor capable of being powered by an A.C. voltage and a device for controlling the direction and the speed of rotation, in which first respective ends of windings of the motor stator are connected to the first respective conduction terminals of the switches of the first circuit.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1 very schematically shows in the form of blocks an example of a current architecture of an asynchronous motor powered by an A.C. voltage;

FIG. 2 shows an example of a current electric diagram of a device for controlling a motor respecting the architecture of FIG. 1;

FIG. 3 shows an embodiment of a detailed electric diagram of a device for controlling the speed and the rotation direction of an asynchronous motor according to the present invention;

FIG. 4 partially shows a variation of the device of FIG. 3;

FIG. 5 partially shows another variation of the device of FIG. 3; and

FIG. 6 very schematically shows in the form of blocks the functions of the control device of FIG. 3.

### DETAILED DESCRIPTION

The same elements have been referred to with the same reference numerals in the different drawings. For clarity, only those elements useful to the understanding of the present invention have been shown in the drawings and will be described hereafter. In particular, the applications of an asynchronous motor controlled by a device according to the present invention have not been detailed, such applications being compatible with the control of any multipolar asynchronous motor.

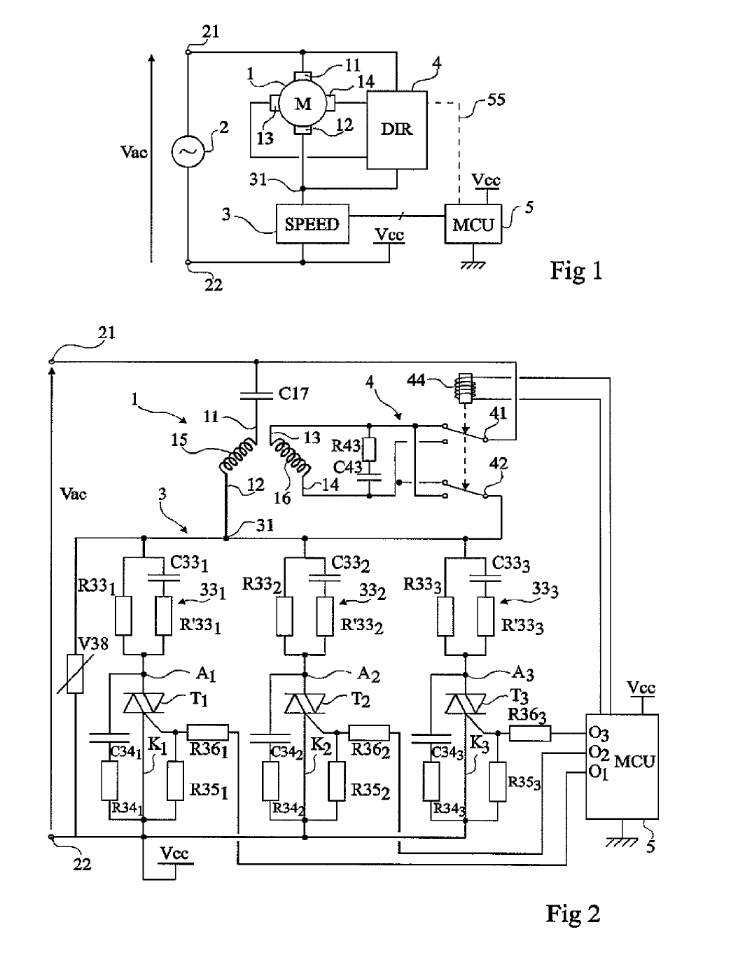

FIG. 1 very schematically shows, in the form of blocks, an example of a current architecture for controlling an asynchronous motor 1 (M) powered by an A.C. voltage Vac, for example, the voltage of electric power supply system 2. It is a multi-speed fan motor capable of operating in both directions (suction-blow). In the shown example, the motor stator has four poles.

Two ends 11 and 12 of a first winding of the stator are respectively connected to a terminal 21 of application of voltage Vac and to a first terminal 31 of a speed selection circuit 3 (SPEED) having its other terminal connected to the other terminal 22 of application of voltage Vac. Two ends 13 and 14 of a second winding of the stator are connected to a circuit 4 (DIR) for reversing the rotation direction, which is supplied between terminal 21 and terminal 31. Speed selection circuit 3 receives several reference values (as many as there are possible speeds) from a control unit 5 (for example, a microcontroller MCU) powered by a low D.C. voltage Vcc. Unit 5 also generally controls the system for reversing the rotation direction (link in dotted lines 55). For voltage reference reasons which will be better understood from the following discussion in relation with FIG. 2, terminal 22 corresponds to the terminal of application of positive voltage Vcc.

FIG. 2 shows an example of a current electric diagram of a device for controlling a motor 1 respecting the architecture of FIG. 1. The two stator windings 15 and 16 have been schematized by inductances. A winding 15 has one end 11 connected, via a capacitive element C17 setting the offset between the winding supplies, to terminal 21, and its other end 12 is connected to terminal 31 of speed setting circuit 3. Circuit 3 is formed from triacs T1, T2, and T3 respectively in series with cells 33₁, 33₂, and 33₃ more or less modifying, according to which triac is turned on, the series impedance with the motor windings to modify its rotation speed. Each cell 33 comprises, in parallel, a resistor R33ᵢ (with i here ranging between 1 and 3) and the series association of a capacitive element C33ᵢ and of a resistor R′33ᵢ. The impedance variation is mainly ensured by the capacitive elements, where the resistors may be identical from one cell to the other. Resistors R′33ᵢ are mainly used to limit the inrush current on powering-on. Resistors R33ᵢ are used to discharge the capacitive element of a cell when it is no longer used. Resistors R33ᵢ have greater values than resistors R′33ᵢ (by a ratio of at least 5). The cells are connected on the one hand to terminal 31 and on the other hand to anode Aᵢ of the corresponding triac Ti. The cathode Kᵢ of each triac Ti is directly connected to terminal 22, also connected to a terminal of application of a positive voltage Vcc. Further, the anode Aᵢ of each triac may be connected to its cathode by a capacitor C34ᵢ in series with a resistor R34ᵢ to limit voltage steps on turning-off of the considered triac. Finally, the gate of each triac is connected, on the one hand to an output Oᵢ of microcontroller 5 by a voltage-to-current conversion resistor R36ᵢ, and on the other hand to its cathode (and thus to terminal 21) by a resistor R35ᵢ.

The speed selection control is performed by selecting that of triacs T1, T2 or T3 which is controlled by microcontroller 5. To enable flowing of a gate current and control the triacs, voltage Vcc is applied on the cathodes thereof to provide a positive voltage reference, and optional resistors R35ᵢ ensure a gate-cathode potential difference desensitizing the gate control.

An element for clipping the voltage across speed selection circuit 3 (for example, a varistor R38) may connect terminals 31 and 22.

On the side of circuit 4 for reversing the motor rotation direction, the other stator winding 16 has its ends 13 and 14 respectively connected across a bipolar switch having a first terminal 41 connected to terminal 21 and having a second terminal 42 connected to terminal 31. In a first position, the switch connects terminal 41 to end 13 of the winding and terminal 42 to end 14 of winding 16. In a second position, end 14 is connected to terminal 21 while end 13 is connected to terminal 31 to reverse the current in the winding, and thus the motor rotation direction. A resistor R43 in series with a capacitor C43 between terminals 13 and 14 limit the overvoltages on switchings. The switch is of relay type and is controlled by a coil 44 having its two ends, for example, powered from microcontroller 5.

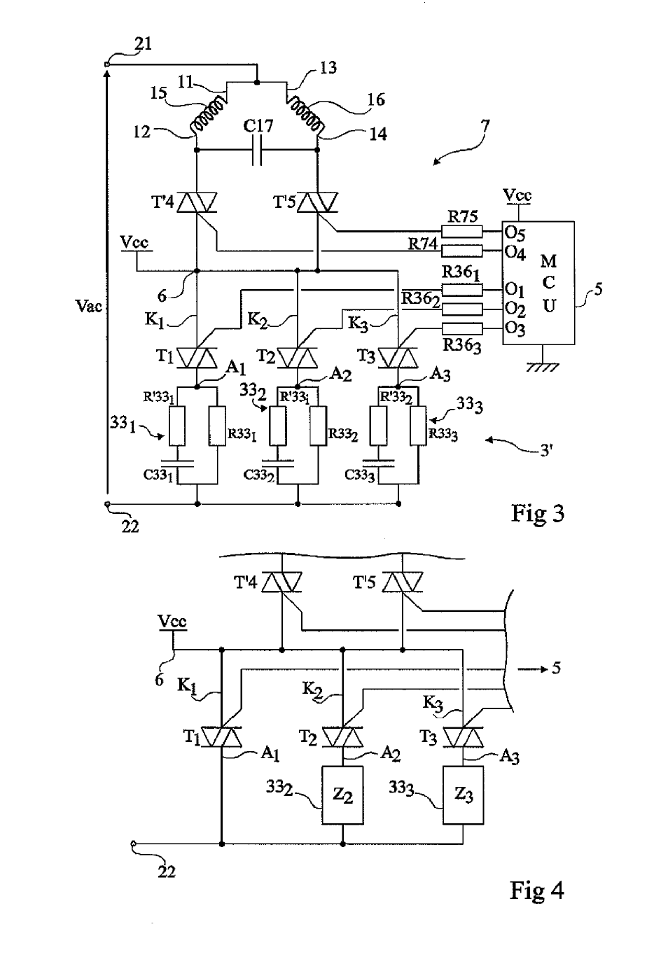

FIG. 3 shows the equivalent electric diagram of a device for controlling an asynchronous motor according to an embodiment of the present invention.

Two windings 15 and 16 of the stator, phase-shifted, enable controlling the motor in one direction or another, and a speed variation is obtained by means of bidirectional switches, for example, triacs.

According to this embodiment of the present invention, first respective ends 12 and 14 of windings 15 and 16 of the stator of motor 1 are each connected to the anode of a triac T′4 or T′5 of a circuit 7 for selecting the motor rotation direction. The respective gates of triacs T′4 and T′5 are, for example, connected to output terminals O4 and O5 of a microcontroller 5 (MCU), or another control circuit capable of providing adapted voltage signals, by resistors R74 and R75. Ends 12 and 14 are further connected to each other by a capacitive phase-shift element C17.

The respective cathodes of triacs T′4 and T′5 are connected to a common reference terminal 6 of the control device. Terminal 6 receives a D.C. voltage Vcc (typically, the most positive potential of a D.C. voltage Vcc, preferably, the same as that supplying unit 5) and is directly connected to the cathodes of triacs T1, T2, and T3 of a speed selection circuit 3′. The number of triacs used for the speed control has been arbitrarily set to 3. This number may be modified according to the number of different desired speeds. The respective anodes of triacs T1, T2, and T3 are connected to a terminal 22 of application of an A.C. voltage Vac by cells 33₁, 33₂, and 33₃, respectively, modifying the impedance in series with the windings. Each cell 33ᵢ (with i ranging between 1 and 3 in this example) is, for example, formed of a parallel association of a cell reset (discharge) resistor R33ᵢ, with a series association of a capacitive element C33ᵢ and an inrush current limiting resistor R′33ᵢ. The respective gates of triacs T1, T2, and T3 are connected to output terminals O1, O2, and O3 of microcontroller 5 by voltage-to-current conversion resistors R36₁, R36₂, and R36₃.

Second respective ends 11 and 13 of the two windings 15 and 16 of the motor stator are connected together to another terminal 21 of application of A.C. voltage Vac.

According to which triac T′4 or T′5 is turned on by microcontroller 5, the motor supply current runs through one or the other of windings 15 or 16 of the stator, which conditions the motor rotation speed.

As for the speed variation, the control uses an operating principle of circuit 3 of FIG. 2, except for the fact that the triacs are inverted (their cathodes are now on the side of circuit 7 to be common with those of triacs T′4 and T′5).

Resistors (R34ᵢ, FIG. 2) and capacitors (C34ᵢ, FIG. 2), not shown in FIG. 3, may be provided in parallel with each triac T1, T2, T3 to limit voltage steps on turning-off.

Resistors (R35ᵢ, FIG. 2) imposing a potential difference between the cathode and the gate of triacs Ti may also be provided.

Similarly, an element (R38, FIG. 2) for clipping the voltage across circuit 3′ may be provided.

FIG. 4 shows the partial electric diagram of an alternative embodiment. One of cells 33ᵢ (in this example, cell 33₁) is omitted, the corresponding triac Ti being then used to control the motor in its maximum rotation speed. For the case where resistors R34ᵢ and capacitors C34ᵢ are provided in the circuit, they are not provided for the triac (T1) having its anode directly connected to terminal 22. Impedances Zᵢ conditioning the other rotation speeds have been symbolized by blocks 33ᵢ. The other elements of the device are similar to those described in relation with FIG. 3.

As a specific example of embodiment, a control device such as illustrated in FIG. 4 has been formed with the following components:

R36₁, R36₂, R36₃, R74, and R75=130 ohms;

R33ᵢ=100 kohms;

R′33ᵢ=47 ohms;

C33₂=5 microfarads;

C33₃=6 microfarads;

C33₁=R33₁=R′33₁=0 (no cell 33₁); and

C17=4.5 microfarads.

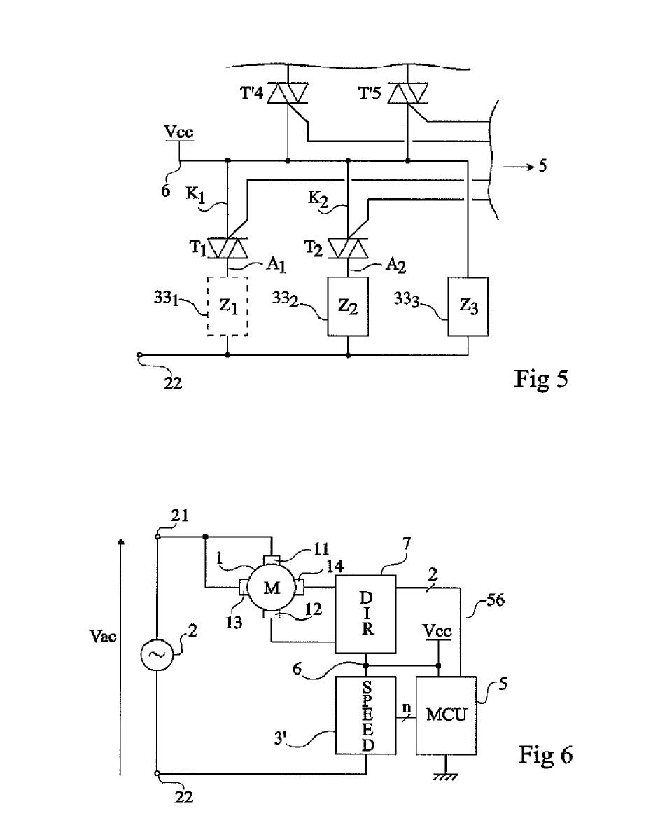

FIG. 5 shows the partial electric diagram of another variation. One of triacs Ti (for example, triac T3, FIG. 3) is replaced with a short-circuit, the corresponding cell 33ᵢ being maintained and setting a default rotation speed of the motor. This speed is then adapted, for example, by the two other triac branches.

The variations of FIGS. 4 and 5 may be combined (absence of block cell 33₁ symbolized by a block in dotted lines in FIG. 5).

FIG. 6 very schematically shows, in the form of blocks, the functional architecture of the device of FIG. 3.

A common reference point 6 is provided between a first circuit 7 (DIR) with bidirectional switches for selecting the motor rotation direction and a second circuit 3′ (SPEED) with bidirectional switches for controlling the motor rotation speed. Accordingly, circuits 7 and 3′ are serially connected. Circuit 7 is controlled by two low-voltage signals (connection 56) originating from a control unit 5 (MCU) while circuit 3′ is controlled by n signals originating from unit 5 according to the number of possible speeds. Point 6 is connected to a D.C. voltage Vcc.

The bidirectional switches of the direction selection circuit and of the speed selection circuit are thus in series, their cathodes being interconnected.

An advantage of the present invention is that the control unit outputs may be uniform. Further, the integration of the device is eased due to the common cathode structure.

Another advantage of the present invention is that it avoids the power consumption of the coil of a relay. Further, the absence of an electromagnetic control relay decreases interferences and the electromagnetic noise.

Among the possible applications of the control circuit of the present invention, fan motors, washing-machine or drier motors, air conditioning fan motors, vacuum pump or vacuum cleaner motors should be noted.

Of course, the present invention is likely to have various alterations, modifications, and improvements which will readily occur to those skilled in the art. In particular, although the present invention has been more specifically described in relation with an example using triacs, its transposition to an implementation based on any bidirectional switch architecture is within the abilities of those skilled in the art based on the functional indications given hereabove. For example, for each switch, an assembly of two thyristors head-to-tail in parallel may be used, one of the two being associated with a control element (optocoupler, pulse transformer, etc.) enabling control by a single signal. A triac however remains preferable. Bidirectional power switches having their control terminal referenced to a power electrode located on the surface opposite to that supporting the control electrode, for example, switches known under trade name ACS, may also be used.

Further, the values to be given to the different components depend on the motor features, on the desired rotation speeds, etc. and are here again adaptable according to the applications.

Moreover, although the present invention more specifically applies to a speed selection between discrete values, it is possible to provide a variable element (for example, a resistor or a variable capacitor) in at least one of cells 33ᵢ to obtain a continuous variation at least across a speed range settable, for example, by the user.

Finally, the generation of the control signals of the different bidirectional switches, for example, by a microcontroller, uses tools within the abilities of those skilled in the art.

Having thus described at least one illustrative embodiment of the invention, various alterations, modifications, and improvements will readily occur to those skilled in the art. Such alterations, modifications, and improvements are intended to be within the spirit and scope of the invention. Accordingly, the foregoing description is by way of example only and is not intended as limiting. The invention is limited only as defined in the following claims and the equivalents thereto.

What is claimed is:

1. A device for controlling the speed and the direction of rotation of an asynchronous motor, comprising:
a first circuit having two individually-controllable bidirectional switches having first conduction terminals connected to a common terminal of application of a D.C. voltage and having second conduction terminals capable of being respectively connected to first ends of windings of the motor stator; and
a second circuit having at least two individually-controllable bidirectional switches in parallel, having first respective conduction terminals connected to said common terminal.

2. The device of claim 1, wherein one of the bidirectional switches of the second circuit has its second conduction terminal directly connected to a terminal of application of an A.C. voltage (Vac), the other bidirectional switches of the second circuit having their second respective conduction terminals connected, by an impedance, to this terminal of application of the A.C. voltage.

3. The device of claim 1, wherein the bidirectional switches of the second circuit have their second respective conduction terminals connected, by an impedance, to a terminal of application of the A.C. voltage.

4. The device of claim 2, wherein a number of bidirectional switches of the second circuit is equal to a number of rotation speeds desired for the motor minus one, an impedance directly connecting said common terminal to said terminal of application of the A.C. voltage.

5. The device of claim 2, wherein a number of bidirectional switches of the second circuit is equal to the number of rotation speeds desired for the motor.

6. The device of claim 2, wherein second respective ends of the windings of the motor are capable of being connected together to another terminal of application of the A.C. voltage, a capacitive element connecting their first respective ends.

7. The device of claim 2, wherein each impedance comprises at least one capacitive element in parallel with a resistive element.

8. The device of claim 1, wherein said bidirectional switches are triacs having their cathodes directly connected to said common terminal.

9. The device of claim 1, wherein respective control terminals of the bidirectional switches are capable of being connected to output terminals of a control circuit providing two-state signals.

10. A device comprising an asynchronous motor capable of being powered by an A.C. voltage and the control device of claim 1, wherein first respective ends of windings of the motor stator are connected to the first respective conduction terminals of the switches of the first circuit.
